(19) United States
(12) Patent Application Publication
(10) Pub. No.: US 2007/0183684 A1
(43) Pub. Date: Aug. 9, 2007

(54) Systems and methods for contrast adjustment

(76) Inventor: Anoop K. Bhattacharjya, Campbell, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/350,303

(22) Filed: Feb. 8, 2006

(51) Int. Cl. G06K 9/40

(52) U.S. Cl. 382/274

(57) ABSTRACT

Systems and methods are disclosed that obtain detail information of an input image by employing multiple filters that present multi-resolution views of the image data. In embodiments, systems and methods perform contrast adjustment by employing a plurality of edge-preserving adaptive filters (EPAF), which generate images at multiple levels of resolution. An edge-preserving adaptive filter comprises a set of filters comprising a set of spatial filters with the same kernel size but with differing spatial orientations. For an input pixel value that is filtered, each of the plurality of edge-preserving adaptive filters outputs the filtered pixel value obtained from its set of filters that has the smallest numerical difference from the input pixel value.

### BACKGROUND

1. Field of the Invention

The present invention relates generally to the field of image processing, and more particularly to systems and methods for performing contrast adjustment of an image.

2. Background of the Invention

In its simplest form, the contrast of an image is a measure of the difference in brightness between light and dark portions of an image. The contrast of an image can affect its appearance. Accordingly, at times, it is beneficial to adjust the contrast of an image in order to improve the appearance of the image.

Various methods have been developed to adjust the contrast of images. For example, contrast stretching is an image enhancement technique that attempts to improve the contrast of an image by adjusting the range of intensity values the image contains. Typically, a histogram representing the distribution of pixel intensities of an image is generated and that distribution is adjusted to span a desired range of values—generally the full range of pixel values that the display device allows. Other contrast adjustment techniques are histogram modeling techniques or histogram equalization. These techniques provide means for modifying the range and contrast of an image by altering the image histogram into a desired shape. Histogram modeling techniques may employ non-linear and non-monotonic transfer functions, which map the intensity values of pixels in the input image to an output image such that the output image possesses a certain distribution of intensities. Traditional pyramidal decomposition schemes, such as wavelets, Laplacian pyramid, and the like, are also used in contrast adjustment methods.

These methods and other traditional methods have difficulty preserving edge information at different lightness levels. For example, contrast stretching may wash out or remove certain image details. Traditional pyramidal decomposition schemes suffer from the problem of edge information propagating across multiple levels of resolution. When the processed levels are recombined into the contrast-adjusted image, edge artifacts result.

Accordingly, systems and methods are needed that can provide contrast adjustment while preserving edge detail information in the image.

### SUMMARY OF THE INVENTION

According to an aspect of the present invention, systems and methods are disclosed that seek to preserve edge detail in an image while performing contrast adjustment.

Embodiments of the present invention obtain detail information by employing multiple edge-preserving adaptive filters that present multi-resolution views of the image data without employing traditional multi-resolution pyramidal decomposition schemes, which cause edge artifacts in the output image due to the problem of edge information propagating across multiple levels of resolution.

In an embodiment, a system for performing contrast adjustment comprises a plurality of edge-preserving adaptive filters (EPAF), which generate images at multiple levels of resolution. An edge-preserving adaptive filter comprises a set of filters. The set of filters comprises a set of spatial filters with the same kernel size but with differing spatial orientations. For an input pixel value that is filtered, each of the plurality of edge-preserving adaptive filters outputs the filtered pixel value obtained from its set of filters that has the smallest numerical difference from the input pixel value.

In an embodiment, each of the set of filters of the edge-preserving adaptive filters may also have at least one color filter. In an embodiment, a filtered pixel value is related to the product of a spatial filter and a color filter.

In an embodiment, the outputs of adjacent edge-preserving adaptive filters are provided to an adder that receives the outputted filtered pixel values and that outputs a difference pixel value by subtracting the filtered pixel values outputted from edge-preserving adaptive filters with adjacent kernel sizes. A clipper receives the difference pixel value and applies a clipping function to the difference pixel value to obtain a clipped pixel value. In an embodiment, the clipping function may be a soft clipping function. An adjustor coupled to receive the clipped pixel value adjusts the clipped pixel value by a gain factor to obtain an adjusted pixel value. A contrast stretcher receives the filtered image from the edge-preserving adaptive filter with the largest kernel size and applies a stretching function to the filtered image to obtain stretched pixel values. An adder receives the stretched pixel values, and for a pixel, adds the stretched pixel value to the corresponding the adjusted pixel values.

In an embodiment, the input to the system represents the logarithm of an image. In such embodiments, an exponentiator may be coupled to receive the sum of the adjusted pixel values and the stretched pixel value and exponentiates the sum to obtain an exponentiated pixel value. In an embodiment, a normalizer may be coupled to receive the exponentiated pixel value and applies a normalizing function to the exponentiated pixel value, thereby normalizing it to the output range of the display device. In an embodiment, the system may include a quantizer for quantizing the image to the required number of bits prior to output.

In an embodiment, a method for performing contrast adjustment of an input image, comprising a plurality of input pixels each having a value, involves applying multi-resolution edge-preserving adaptive filters. The edge-preserving adaptive filters each comprise a set of filters. In an embodiment, a set of filters comprises a set of spatial filters with the same kernel size but with differing spatial orientations. The differing spatially-oriented filters help preserves the edge features in the input image. To achieve multi-resolution, the kernel size, which has an associated region of support, of the set of spatial filters of an edge-preserving adaptive filter differs from the other edge-preserving adaptive filters' sets of spatial filters. For an input pixel that is filtered, each of the edge-preserving adaptive filters outputs the filtered pixel value obtained from its set of filters that is closest to, or has the smallest numerical difference from, the input pixel value. In an embodiment, for an input pixel value that is filtered, each edge-preserving adaptive filter applies the filter from its set of filters that yields the filtered pixel value closest to the input pixel value.

In an embodiment, each of the set of filters may also comprise at least one color filter, such as a color distance function, wherein a filtered pixel value is related to the product of a spatial filter and a color filter.

In an embodiment, the contrast adjustment method also comprises obtaining a difference pixel value by subtracting the filtered pixel values outputted from edge-preserving adaptive filters with adjacent kernel sizes; applying a clipping function to the difference pixel value to obtain a clipped pixel value; and adjusting the clipped pixel value by a gain factor to obtain an adjusted pixel value. In an embodiment, the clipping function may be a soft clipping function.

In an embodiment, the filtered image obtained from the edge-preserving adaptive filter with the largest region of support is stretched to obtain a stretched pixel value of the input pixel value. The stretched pixel value is added to all of the adjusted pixel values for that input pixel to obtain an output pixel value.

In an embodiment, the input image may represent the logarithm of an image. In such embodiments, the contrast adjustment method may also comprise exponentiating the sum of the adjusted pixel value and the stretched input pixel values to obtain an exponentiated pixel value; and applying a normalizing function to the exponentiated pixel value. In an embodiment, the normalized value may be quantized to the required number of bits for a specific display device.

An embodiment of the present invention may comprise a computer-readable medium carrying one or more sequences of instructions which, when executed by one or more processors, cause the one or more processors to perform a portion or all of the steps of discussed above.

Although the features and advantages of the invention are generally described in this summary section and the following detailed description section in the context of embodiments, it shall be understood that the scope of the invention should not be limited to these particular embodiments. Many additional features and advantages will be apparent to one of ordinary skill in the art in view of the drawings, specification, and claims hereof.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. (“FIG.”) 1 is a functional block diagram illustrating an exemplary system in which exemplary embodiments of the present invention may operate.

FIG. 2 depicts an exemplary method for performing contrast adjustment according to an embodiment of the present invention.

FIG. 3 depicts an exemplary method for applying edge-preserving adaptive filters according to an embodiment of the present invention.

FIG. 4 illustrates a set of spatial filtering kernels for an edge-preserving adaptive filter according to an embodiment of the present invention.

FIG. 5 depicts an exemplary color distance function according to an embodiment of the present invention.

FIG. 6 depicts an exemplary soft clipping function according to an embodiment of the present invention.

### DETAILED DESCRIPTION OF THE INVENTION

In the following description, for purposes of explanation, specific details are set forth in order to provide an understanding of the invention. It will be apparent, however, to one skilled in the art that the invention can be practiced without these details. One skilled in the art will recognize that embodiments of the present invention, described below, may be performed in a variety of ways and using a variety of means and should not be construed as limited to the embodiments set forth herein. Rather, these embodiments are provided so that this disclosure will convey the scope of the invention to those skilled in the art. Those skilled in the art will also recognize additional modifications, applications, and embodiments are within the scope thereof, as are additional fields in which the invention may provide utility. Accordingly, the embodiments described below are illustrative of specific embodiments of the invention and are meant to avoid obscuring the invention.

Reference in the specification to “one embodiment” or “an embodiment” means that a particular feature, structure, characteristic, or function described in connection with the embodiment is included in at least one embodiment of the invention. Furthermore, the appearance of the phrase “in one embodiment,” “in an embodiment,” or the like in various places in the specification are not necessarily all referring to the same embodiment.

### A. Exemplary System in which Embodiments of the Present Invention may Operate

Various systems in accordance with the present invention may be constructed. FIG. 1 is a block diagram illustrating an exemplary system 100 in which exemplary embodiments of the present invention may operate. It shall be noted that the present invention may operate, and be embodied in, other systems as well.

Depicted in FIG. 1 is an input image 105 received by system 100. Because the use of logarithms helps maintain multi-resolution detail information during the course of the computation, in an embodiment, the input 105 to system 100 may be the logarithm of an image or may be converted to a logarithm of the image. In an alternative embodiment, the input 105 may have been or may be mapped to a perceptually uniform color space. Coupled to receive the input image 105 is a plurality of edge-preserving adaptive filters (EPAF) 110, which generate images at multiple levels of resolution. The outputs of adjacent edge-preserving adaptive filters are provided to an adder 115 that outputs the difference between the edge-preserving adaptive filter outputs. Adder outputs are each coupled to a clipper 120 for clipping the signal and an adjustor or amplifier 125 for adjusting the clipped signal by a gain factor. The output of the edge-preserving adaptive filter with the largest region of support is supplied to a contrast stretcher 135. The adjusted signals are combined with adders 130 to the output of the contrast stretcher 135 to obtain an output image 145. In an embodiment, system 100 may include an exponentiator (not shown) and a normalizer (not shown) for exponentiating the image and normalizing it to the output range of the display device. In an embodiment, system 100 may include a quantizer (not shown) for quantizing the image to the required number of bits prior to output.

It shall be noted that the terms “coupled” or “communicatively coupled,” whether used in connection with modules, devices, system components, or functional blocks, shall be understood to include direct connections, indirect connections through one or more intermediary devices, and wireless connections. It shall also be understood that throughout this discussion that the system components may be described as separate components, but those skilled in the art will recognize that the various components, or portions thereof, may be subdivided into separate units or may be integrated together. It shall be noted that one or more portions of system 100 may be implemented in software, hardware, firmware, or a combination thereof.

It shall be noted that the present invention may be incorporated into or used with a display devices, including but not limited to, computers, personal data assistants (PDAs), mobile devices, cellular telephones, digital cameras, CRT displays, LCD displays, printers, and the like. In addition, embodiments of the present invention may relate to computer products with a computer-readable medium or media that have computer code thereon for performing various computer-implemented operations. The media and computer code may be those specially designed and constructed for the purposes of the present invention, or they may be of the kind well known and available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

### B. Exemplary Methods

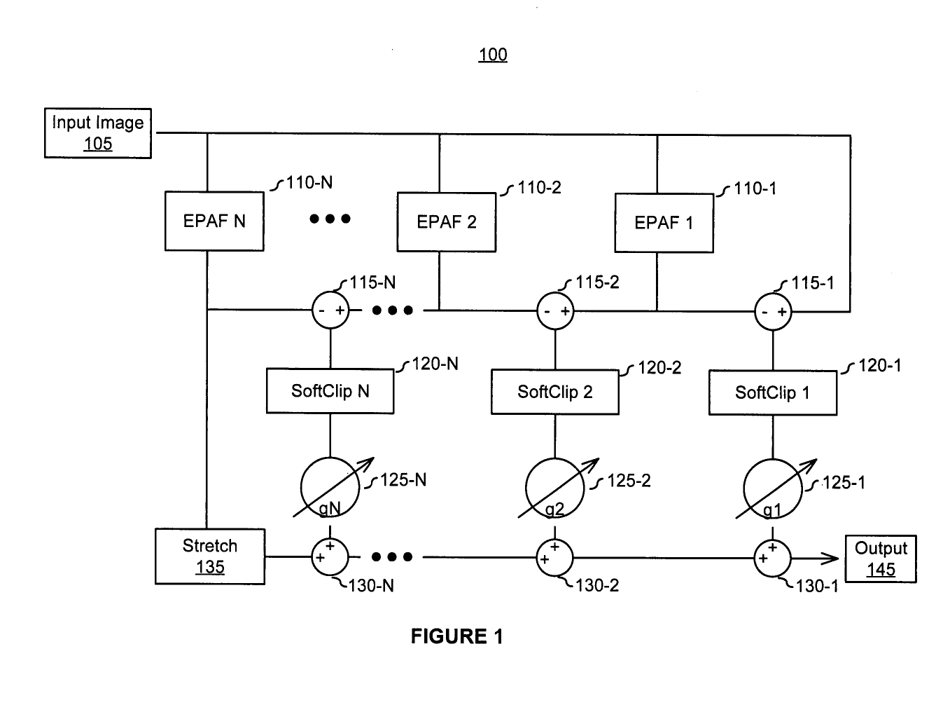

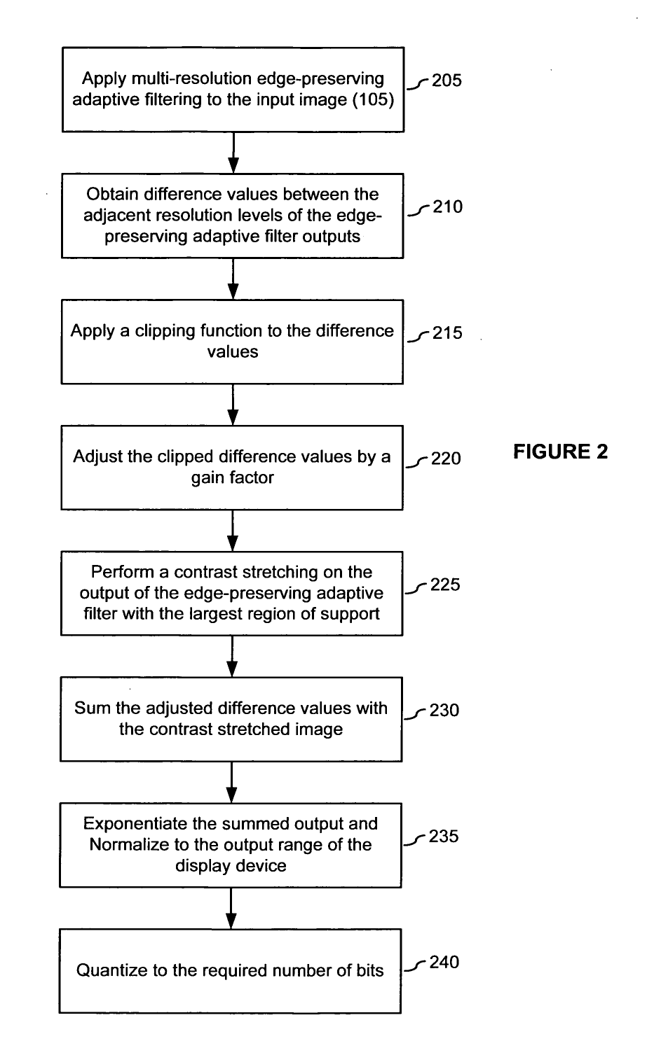

Turning to FIG. 2, depicted is an illustration of a method for adjusting contrast of an input image according to an embodiment of the invention. In an embodiment, multi-resolution edge-preserving adaptive filters are applied (205) to the input image 105. In an embodiment, the input to system 100 may be the logarithm of the input image or may be converted to the logarithm of the input image. In an alternative embodiment, the input image may have been or may be mapped to a perceptually uniform color space. Although not depicted in FIG. 2, embodiments of the method may also include removing halftones or descreening the input image 105.

The edge-preserving adaptive filtering may be applied to generate images at multiple levels of resolution. In an embodiment, an edge-preserving adaptive filter, EPAF k 110, denotes filtering with a set of filters with support over a square of pixels with an edge size of 2k+1 pixels. One skilled in the art will recognize that the present methods may be adapted for use with filtering kernels with different edge size configurations, including without limitation even-numbered edge sizes.

In an embodiment, the filtering for the edge-preserving adaptive filters, EPAF k, proceeds with a set of 2k+3 filter kernels. According to an embodiment, the largest filter kernel in the set of filter kernels may be a symmetric two-dimensional (2-D) Gaussian kernel. The remaining 2k+2 kernels may be oriented Gaussian kernels with the principal axis aligned along the 2k+2 directions defined by the center and the pixels along the edge of the region of support.

Consider, for example, edge-preserving adaptive filter 1, EPAF 1 110-1, as depicted in FIG. 1. In the embodiment described in the preceding paragraph, the edge size of the kernel is:
2k+1=2·1+1=3.

The number of filters in the set of kernel filters is:
2k+3=2·1+3=5.

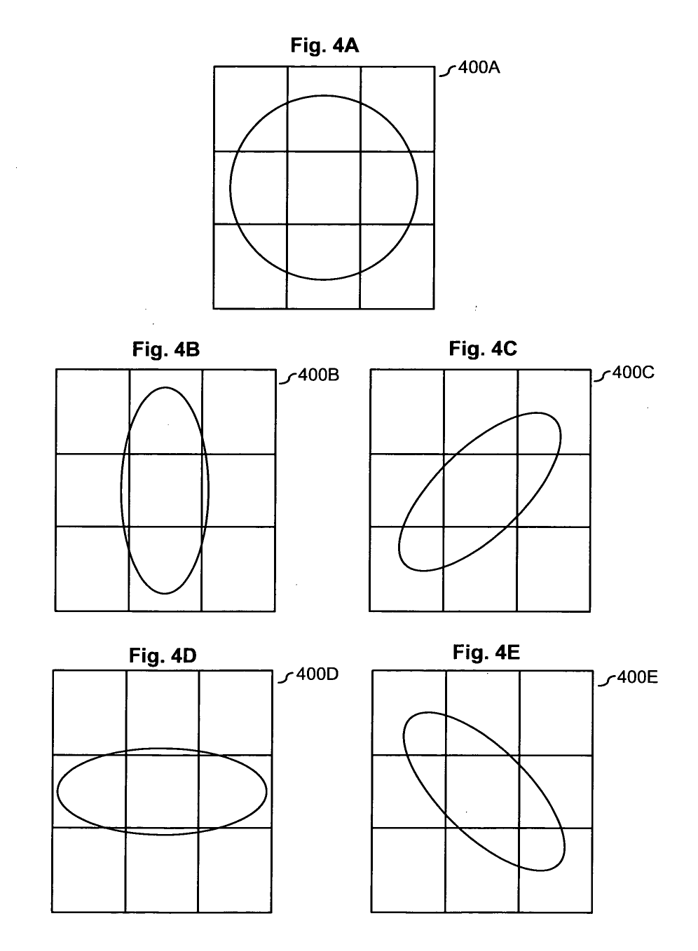

FIGS. 4A-4E graphically illustrates an embodiment of a set of edge-preserving adaptive filters 400 for EPAF 1 110-1. FIG. 4A depicts the largest filter kernel 400A, a symmetric two-dimensional (2-D) Gaussian kernel, of the set of filtering kernels 400. FIGS. 4B-4E depict the remaining four kernels 400B-400E of the set of filtering kernels 400. The filters 400B-400E are oriented Gaussian kernels with the principal axis aligned along the directions defined by the center and the pixels along the edge of the region of support. One skilled in the art will recognize that as the value k increase, the number of orientations also increases; hence the number of filter kernels in the set of filter kernels may also increase. In an embodiment, the ratio between the major and minor axis of the ellipse characterizing the oriented kernels may be predefined based on the number of edge-preserving adaptive filters used in the system 100. It shall be understood that the filtering kernels are not limited to Gaussian filters or to symmetrical or elliptically-shaped filters, but rather, the filter shapes may be regularly shaped, irregularly shaped, or a combination thereof. For example, in an embodiment, the shape of the spatial filters may be determined by the type or nature of the images to be filtered. If the image to be filtered comprises edges of certain orientations or is predominated by edges in certain orientations, the set of spatial filters may be adapted accordingly. For example, if the image to be filtered comprises one or more regular shapes or patterns, such as, for example, tiles, a picket fence, pebbles, geometric art, etc., the set of filters may be designed to relate to the edge patterns likely to occur in the image. One skilled in the art will also recognize that a set of filters need not be limited to having 2k+3 filters but may have more or fewer filters in the set.

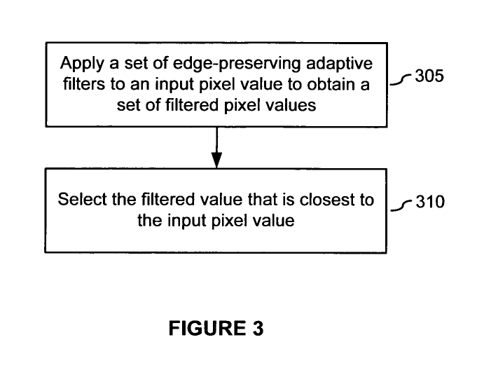

FIG. 3 depicts an implementation utilizing the edge-preserving adaptive filters. The set of filter kernels are applied (305) to an input pixel value from the input image 105. In an embodiment, the filtered value that is closest to the input pixel value is outputted from the edge-preserving adaptive filter (310). Stated in a generalized manner, to filter with edge-preserving adaptive filter k, each of the 2k+3 filters are applied to a given input pixel value, and the output is given by the filtered pixel result that is closest to the original pixel value.

In an embodiment, the edge-preserving adaptive filtering 110 may also include filtering based not only on the spatial orientation but also on color distance. For example, filtering may be performed in a manner analogous to using sigma filters, where the weight of a given pixel within the region of support is determined by both its spatial distance and its color distance to the pixel at the location to be filtered. In an embodiment, the weight of the pixel within the filter kernel's region of support may be related to the product of the weight obtained from the spatial filter and the weight obtained from the color-distance filter. It should be noted that a spatial filter combined with one or more color filters may be construed as a single filter within a set of filters.

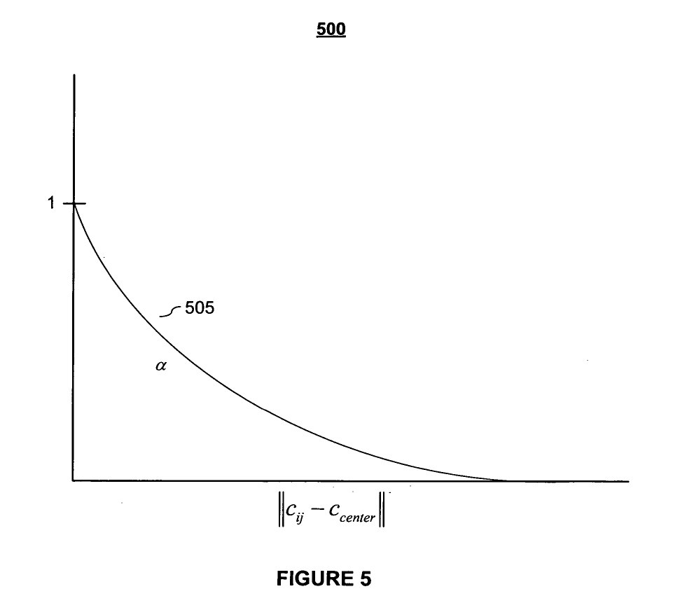

In an embodiment, instead of using a sharp color-distance cutoff as in a traditional sigma filter, a smoothly decaying function of color distance may be used. FIG. 5 depicts an exemplary color distance function, α(∥cᵢⱼ−c_{center}∥) 505, according to an embodiment of the present invention. As depicted in FIG. 5, the function is configured such that as the color distance difference between a pixel and the pixel to be filtered increases, the output of the function reduces to zero. That is, as the color distance between the pixel increases, the weight given that pixel in the filtering decreases. It should be noted that no particular color distance function 505 is critical to the present invention; accordingly, one skilled in the art will recognize that other color distance functions may be used. One skilled in the art will recognize that other filtering configurations may be employed, including without limitation, any class of spatial and color filtering. It shall be understood that references to color distance shall also include grayscale images.

An embodiment of the edge-preserving adaptive filtering with spatial and color distance filtering may be represented according to the following mathematical equations. An embodiment of the present invention may comprise a number, k, of edge-preserving adaptive filters, and each edge-preserving adaptive filter comprises a set of filters. Accordingly, let kₘ denote filter, m, of edge-preserving adaptive filter EPAF k. Given an edge-preserving adaptive filter, EPAF k, the weighted factors for a filter, m, from the set of spatial filters in EPAF k, may be denoted as wᵢⱼ^{k}^{ₘ}. Let c_{center} denote the color value of the pixel to be filtered and cᵢⱼ represent the color values of the pixels within the region of support. The weighed factor from a color distance function may be denoted as αᵢⱼ^{k}^{ₘ}(∥cᵢⱼ−c_{center}∥). It should be noted that the color distance function may vary between pixels within the region of support and may vary between filters. The filtered pixel value for filter m of EPAF k may be obtained according to the following formula:

$$\begin{matrix}{c}_{center}^{{k}_{m}} = {\sum }_{ij} {c}_{ij} {s}_{ij}^{{k}_{m}} \\ where & ( 1 ) \\ {s}_{ij}^{{k}_{m}} = \frac{{w}_{ij}^{{k}_{m}} {α}_{ij}^{{k}_{m}} ( ‖ {c}_{ij} - {c}_{center} ‖ )}{{\sum }_{ij} {w}_{ij}^{{k}_{m}} {α}_{ij}^{{k}_{m}} ( ‖ {c}_{ij} - {c}_{center} ‖ )} & ( 2 )\end{matrix}$$

Alternatively, the filtered color value may be obtained according to the following formula:

$${c}_{center}^{{k}_{m}} = \frac{{\sum }_{ij} {w}_{ij}^{{k}_{m}} {α}_{ij}^{{k}_{m}} ( ‖ {c}_{ij} - {c}_{center} ‖ ) {c}_{ij}}{{\sum }_{ij} {w}_{ij}^{{k}_{m}} {α}_{ij}^{{k}_{m}} ( ‖ {c}_{ij} - {c}_{center} ‖ )} \qquad ( 3 )$$

A filtered pixel value is obtained for each of the filters in EPAF k's set of filters to obtain a set of filtered pixel values (e.g., c_{center}^{k}^{₁}, c_{center}^{k}^{₂}, . . . c_{center}^{k}^{_{M}}). The filtered pixel value outputted from EPAF k, denoted c_{center}^{k}, is selected from the set of the filtered pixel value. The outputted filtered pixel value, c_{center}^{k}, is the filtered pixel value that has the smallest difference between itself and the original value of the pixel to be filtered. Consider, for purposes of illustration, the operation of EPAF 4. Assume, for the purposes of this example, that EPAF has 11 filters in its set of filters and wherein each filter in the set of filters represents a combined spatial filter and color filter. EPAF 4 will generate 11 filtered pixel values for an input pixel—one for each of the filters in its set of filters. EPAF 4 outputs the filtered pixel value selected from among the 11 filtered pixel values that is closest in value to the input pixel value. Assuming that the filtered pixel value for filter 10 is closest to the input pixel value, the output of EPAF 4, c_{center}⁴, will be:
c_{center}⁴=c_{center}⁴^{₁₀}.

Returning to FIG. 2, in an embodiment, the difference between outputs of successive edge-preserving adaptive filters, EPAF k+1 and EPAF k, is determined (210). In an embodiment, this difference information may be clipped using a clipping function. In an embodiment, the clipping function may be a soft clipping function to reduce noise in the pixels.

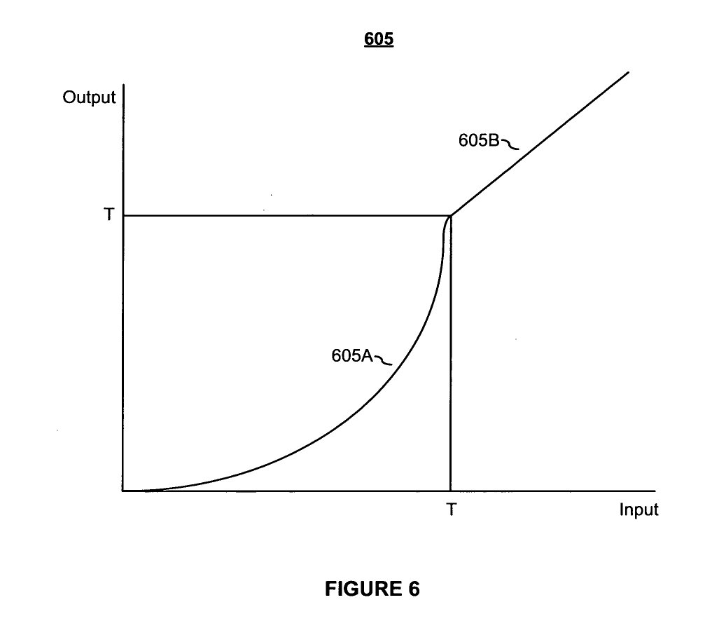

An embodiment of a soft clipping function 605 is illustrated in FIG. 6. As illustrated in the FIG. 6, for a specified threshold T, the output at a given pixel is unchanged for inputs equal to or greater than T. However, inputs less that T are reduced towards zero (0) using a smooth function 605A that is equal to zero (0) for an input of zero (0), equal to T for an input of T, and has a derivative of one (1) at T. Having a derivative of one (1) at T smoothes the transition between the function 605A for values below T and the function 605B for values equal to or greater than T. It shall be noted that the clipping function shall not be limited by the shape, profile, or values of the exemplary soft-clipping function 605 depicted in FIG. 6. One skilled in the art will recognize that other functions may be employed.

In an embodiment, the value of T may be selected. In one embodiment, T may be selected experimentally. In an alternative embodiment, T may be selected using one or more calibration techniques. For example, a known input, such as a flat color image, may be applied to an edge-preserving adaptive filter. Given the output, the noise for the edge-preserving adaptive filter may be determined or approximated, and T may be selected to account for noise at each edge-preserving adaptive filter output. Given a noise level, T may be set varying levels, including, without limitation, minimum noise level, maximum noise level, average noise level, or statistical noise level. It shall be noted that the value of T may vary among the soft-clipping functions 120.

Returning to FIG. 2, in an embodiment, after clipping, the difference values may be adjusted (220) by a gain factor (gₖ), before being added to the reconstructed image. It should be noted that one or more of the gain factors 125, gₖ, may be the same, or they may each have a different value. In an embodiment, the values of gₖ may be determined based on the number of edge-preserving adaptive filters, and prior information about which scales contain interesting image-edge information. One skilled in the art will recognize that the multi-level resolution analysis provide independent control of the various levels. For example, because laser printers typically cannot display fine details, the fine levels of the EPAFs in the multi-level resolution filtering may be set with higher gains than the coarse portions. Accordingly, it shall be noted that the gain may be adjusted based upon a number of factors, including without limitation, user preferences, input device characteristics, display device characteristics, source noise characteristics, image characteristics, and the like. It shall also be noted that a gain factor may attenuate a signal; that is, the gain factor may be:
0≦gₖ. (4)

In an embodiment, the output of the edge-preserving adaptive filter with the largest support is stretched (225). Contrast stretching may be performed using any of a number of methods known to those of skill in the art. In one embodiment, a histogram of the EPAF-filtered image may be used to determine the levels at the 10^{th} and 90^{th} percentiles. These levels may then be rescaled uniformly to a predefined range to perform the stretch operation. One skilled in the art will recognize that other histogram equalization methods may also be used for performing the stretch operation (225).

The scaled, clipped differences of the edge-preserving adaptive filter outputs may be added to the stretched result to form the final output. In an embodiment, the output image may be exponentiated and normalized (230) to the output range of the display device. In an embodiment, the image may be quantized (235) to the required number of bits prior to outputting the output image 145.

One skilled in the art shall recognize that the system and methods may be reordered or reconfigured from the exemplary embodiments provided herein to obtain the same or similar results, and such reordering are within the scope of the present invention.

While the invention is susceptible to various modifications and alternative forms, specific examples thereof have been shown presented herein. It should be understood, however, that the invention is not to be limited to the particular forms disclosed, but to the contrary, the invention is to cover all modifications, equivalents, and alternatives falling within the spirit and scope of the appended claims.

I claim:

1. A method for performing contrast adjustment of an input image comprising a plurality of input pixels each having a value, the method comprising the steps of:
applying, to the input image, a plurality of edge-preserving adaptive filters, each comprising a set of filters comprising a set of spatial filters with differing spatial orientations and with a kernel size differing from the other edge-preserving adaptive filters' sets of spatial filters; and
wherein, for an input pixel value that is filtered, each of the plurality of edge-preserving adaptive filters outputs the filtered pixel value obtained from its set of filters that has the smallest numerical difference from the input pixel value.

2. The method of claim 1 wherein each of the set of filters further comprises at least one color filter.

3. The method of claim 2 wherein a filtered pixel value is related to the product of a spatial filter and at least one color filter.

4. The method of claim 2 further comprising the steps of:
obtaining a difference pixel value by subtracting the filtered pixel values outputted from edge-preserving adaptive filters with successive spatial filter kernel sizes;
applying a clipping function to the difference pixel value to obtain a clipped pixel value;
adjusting the clipped pixel value by a gain factor to obtain an adjusted pixel value;
applying a contrast stretching function to the filtered image from the edge-preserving adaptive filter with the largest spatial filter kernel size to obtain a stretched pixel value; and
adding the adjusted pixel value to the stretched pixel value.

5. The method of claim 4 wherein the clipping function is a soft clipping function.

6. The method of claim 2 wherein the input image represents the logarithm of an image.

7. The method of claim 6 further comprises the steps of:
exponentiating the sum of the adjusted pixel value and the stretched pixel value to obtain an exponentiated pixel value; and
applying a normalizing function to the exponentiated pixel value.

8. A computer-readable medium carrying one or more sequences of instructions which, when executed by one or more processors, cause the one or more processors to perform at least the steps of claim 1.

9. A method for performing contrast adjustment of an input image comprising a plurality of input pixels each having a value, the method comprising the steps of:
applying a first edge-preserving adaptive filter comprising a first set of spatial filters with differing spatial orientations and with a first region of support to an input pixel value to obtain a first set of filtered pixel values and selecting a first filtered pixel value from the first set of filtered pixel values that has a value closest to the input pixel value;
applying a second edge-preserving adaptive filter comprising a second set of spatial filters with differing spatial orientations and with a second region of support to the input pixel value to obtain a second set of filtered pixel values and selecting a second filtered pixel value from the second set of filtered pixel values that has a value closest to the input pixel value;
obtaining a difference pixel value by subtracting the second filtered pixel value from the first filtered pixel value;
applying a clipping function to the difference pixel value to obtain a clipped pixel value;
adjusting the clipped pixel value by a gain factor to obtain an adjusted pixel value;
applying a largest edge-preserving adaptive filter comprising a set of spatial filters with differing spatial orientations and with a largest region of support to the input pixel value to obtain a set of filtered pixel values and selecting a filtered pixel value from the set of filtered pixel values that has a value closest to the input pixel value and applying a contrast stretching function to the filtered pixel value to obtain a stretched pixel value; and
adding the adjusted pixel value to the stretched pixel value.

10. The method of claim 9 wherein each of the edge-preserving adaptive filters further comprises at least one color filter.

11. The method of claim 10 wherein a filtered pixel value is related to the product of a spatial filter and at least one color filter.

12. The method of claim 9 wherein the second edge-preserving adaptive filter is the largest edge-preserving adaptive filter.

13. The method of claim 9 wherein the clipping function is a soft clipping function.

14. The method of claim 9 wherein the input image represents the logarithm of an image.

15. The method of claim 14 further comprises the steps of:
exponentiating the sum of the adjusted pixel value and the stretched pixel value to obtain an exponentiated pixel value; and
applying a normalizing function to the exponentiated pixel value.

16. A computer-readable medium carrying one or more sequences of instructions which, when executed by one or more processors, cause the one or more processors to perform at least the steps of claim 9.

17. A system for performing contrast adjustment of an input image comprising a plurality of input pixels each having a value, the system comprising:
a plurality of edge-preserving adaptive filters coupled to receive the input image, said edge-preserving adaptive filters each comprising a set of filters comprising a set of spatial filters with differing spatial orientations and with a kernel size differing from the other edge-preserving adaptive filters' sets of spatial filters; and
wherein, for an input pixel value that is filtered, each of the plurality of edge-preserving adaptive filters outputs the filtered pixel value obtained from its set of filters that has the smallest numerical difference from the input pixel value.

18. The system of claim 17 wherein each of the set of filters further comprises at least one color filter and wherein a filtered pixel value is related to the product of a spatial filter and at least one color filter.

19. The system of claim 17 further comprising:
an adder coupled to received the filtered pixel values and that outputs a difference pixel value by subtracting the filtered pixel values outputted from edge-preserving adaptive filters with successive spatial filter kernel sizes;
a clipper coupled to receive the difference pixel value and that applies a clipping function to the difference pixel value to obtain a clipped pixel value;
an adjustor coupled to receive the clipped pixel value and that adjusts the clipped pixel value by a gain factor to obtain an adjusted pixel value;
a contrast stretcher coupled to receive the filtered image from the edge-preserving adaptive filter with the largest spatial filter kernel size and that applies a stretching function to the filtered image to obtain a stretched pixel value; and
an adder coupled to receive the stretched pixel value the contrast stretcher and to adding the adjusted pixel value to the stretched pixel value.

20. The system of claim 19 wherein the input image represents the logarithm of an image and the system further comprises:
an exponentiator coupled to receive the sum of the adjusted pixel value and the stretched pixel value and that exponentiates the sum to obtain an exponentiated pixel value; and
a normalizer coupled to receive the exponentiated pixel value and that applies a normalizing function to the exponentiated pixel value.
